(19) United States
(12) Patent Application Publication
(10) Pub. No.: US 2026/0326210 A1
(43) Pub. Date: Oct. 22, 2026

(54) DRAWBACK TOOL HOLDER AND SPRING COLLET AND NUT THEREFOR

(71) Applicant: ISCAR LTD., TEFEN (IL)

(72) Inventors: CHEN BALBES, KIRYAT ATA (IL); MARK ASHQAR, FASUTA (IL); NIR COHEN, KUBBUTZ SAAR (IL)

(73) Assignee: ISCAR LTD., TEFEN (IL)

(21) Appl. No.: 19/695,635

(22) Filed: Jun. 2, 2026

Related U.S. Application Data
(63) Continuation of application No. PCT/IL2024/051118, filed on Nov. 26, 2024.
(60) Provisional application No. 63/611,478, filed on Dec. 18, 2023.

(51) Int. Cl. B23B 31/20

(52) U.S. Cl. CPC B23B 31/202; B23B 2231/2008; B23B 2231/2043; B23B 2260/106

(57) ABSTRACT

A compact mechanical-type holder with clamping forces, precision and small runout comparative to a heat-shrink holder, and a collet designed for such holder. The collet including an externally tapering collet tapered portion, and flexibility slits opening out to the collet tapered portion. The collet inner peripheral surface includes a recess located between a first cylindrical clamping surface and a second cylindrical clamping surface.

### CROSS REFERENCE TO RELATED APPLICATIONS

This application is a bypass continuation of International Application No. PCT/IL2024/051118 filed Nov. 26, 2024, which claims the benefit of U.S. Provisional Application No. 63/611,478 filed Dec. 18, 2023. The entire contents of each of the above applications are hereby incorporated by reference.

### FIELD OF THE INVENTION

The subject matter of the present application relates to a drawback tool holder (hereinafter also “holder”), designed to provide similar performance to a heat-shrink holder except via a mechanical clamping design. It also relates to a spring collet (hereinafter also “collet”) and nut developed for such holder.

### BACKGROUND OF THE INVENTION

Heat-shrink tool holders are extremely compact as they do not require additional parts to clamp a tool having a cylindrical shank and a cutting portion (the tool typically being, but not limited to, an end mill). Clamping is achieved by a tool being inserted inside a cylindrical bore of the holder's body. Before insertion, the metal portion of the body encircling and forming the bore is expanded by heating the holder in an induction machine. Subsequent to insertion, the holder is allowed to cool causing the metal portion to contract and clamp a shank of the tool. This type of clamping allows extremely high clamping forces, small runout and precision clamping reducing vibrations, all with an extremely compact design since the holder body directly clamps the tool without an intermediary component such as a collet.

The few disadvantages of the above-described heat-shrink holder is that a dedicated induction machine is required for insertion and removal of the tool, and there is a safety hazard involved with the heating application.

In order to achieve the high clamping force of a heat-shrink tool holder with a mechanical tool holder, several designs were developed by the present applicant, resulting in a nut and pin system.

Subsequent to development of the nut and pin system, JP2016-124070A, assigned to Yukiwa Seiko CO LTD, was found which, for example in FIG. 3, also discloses a nut and pin system except in a chucking system which pushes a three-piece chuck axially forward into the holder body to clamp a tool.

In contrast to said chucking system, the tool holder disclosed herein is directed to a tool holder of a “drawback” type. In particular a drawback tool holder comprising a collet. The collet having a tapered portion the largest diameter of which is at a front end thereof and which tapers in diameter with increasing distance from the front end (which is the opposite tapering direction to the above-described chucking system) and is pulled rearwardly into a holder body to clamp a tool when said tapered portion is compressed by a corresponding tapered portion on the holder body.

Subsequently, a drawback tool holder having a nut and pin system and a tapered collet (model number “SN20-PCH6-125”; sold under the name “Pencil Mill Chucks with Straight Shanks”; hereinafter “Yukiwa Seiko's holder”) was found in an online catalogue (www.yukiwa.co.jp/e/ts/pmc_01.php#4). Aside from the collet (model number “YPC 6”) which is shown online, no published drawings of the nut and pin system are known to the applicant and notable differences between the disclosed collet and Yukiwa Seiko's holder will be described below.

### SUMMARY OF THE INVENTION

In accordance with a first aspect of the subject matter of the present application, there is provided a collet having an elongated shape and a collet axis which extends longitudinally through a center of the collet, the collet comprising: a collet front end; a collet rear end located opposite the collet front end; a collet body extending between the collet front end and the collet rear end; a collet rearward direction from the collet front end to the collet rear end and parallel to the collet axis; a collet forward direction opposite to the collet rearward direction; a collet outward direction perpendicular to the collet axis and from the collet axis towards the collet body; a collet inward direction opposite to the collet outward direction; a collet diameter DC at the collet front end; a collet axial length LC; and a collet front bore opening out to the collet front end at a collet front opening, the collet front bore extending rearward from the collet front end; the collet body comprising: a collet outer peripheral surface in turn comprising a collet tapered portion axially adjacent to the collet front bore; a collet inner peripheral surface surrounding at least the collet front bore; and a plurality of flexibility slits formed in the collet body and opening out at one side to the collet front bore and at the other side to the collet tapered portion; a tapering portion axial length LT is defined from the collet front end to a distal end of the collet tapered portion from the collet front end; wherein the collet inner peripheral surface comprises: a first cylindrical clamping surface in turn comprising a first forwardmost point, a first rearwardmost point, a first bore diameter D1, and a first axial length L1 measurable from the first forwardmost point to the first rearwardmost point; a second cylindrical clamping surface in turn comprising a second forwardmost point, a second rearwardmost point, a second bore diameter D2 equal to the first bore diameter D1, and a second axial length L2 measurable from the second forwardmost point to the second rearwardmost point; and a recess located between the first cylindrical clamping surface and the second cylindrical clamping surface and having a third axial length L3 from the first rearwardmost point to the second forwardmost point, and a recess bore diameter D3 fulfilling the conditions: D3>D1 and D3>D2.

During development of the drawback tool holder disclosed herein it was discovered that the collet clamping could be improved by introducing a recess between two cylindrical clamping surfaces at a tapered area of the collet which is compressed. Without being bound to theory, it is believed that known collets are devoid of such recess because it is counterintuitive to reduce the clamping area on a tool by introducing a recess. Additionally, such recess is a non-trivial feature to produce requiring a precision internal boring machining process to be carried out internally in an extremely small bore.

It was proposed to introduce such recess to ensure a tool is clamped adjacent to a collet front end and as rearward as possible in the compressed region of the collet (i.e. axially adjacent to the tapering). By holding the tool at two distal portions of a shank, it was discovered that a previously less defined clamping area can be more defined, allowing better clamping (than would be the case if the tool is mainly gripped near the collet's front end-thereby reducing the chance of pullout), less vibrations (expected due to the more likely certain grip at a greater distance from the collet front end) and excellent (small) runout was achieved even with the additional of an extra component, i.e. a collet (which is not needed by heat-shrink holders). Finally, it is noted that no inferior performance (compared to a heat-shrink holder) was found when reducing the comparative length of the clamping area.

It should be understood that such recess may be independently advantageous even for spring collets which are not further configured for drawback tool holders. Nonetheless, this construction was found particularly advantageous for a drawback tool holder.

The collet can preferably further comprise a collet connection portion from the collet tapering portion to the collet rear end.

While the collet connection portion can be configured with, for example a collet aperture (not shown) integrally formed portion for receiving a pin of the holder, it is preferred to provide the collet connection portion with back bore formed with a collet thread for connecting to a collet drawback element which in turn is formed with a drawback aperture for receiving the pin. While the collet drawback element is an additional component, it facilitates easier removal of the collet for replacement by a different size collet. Nonetheless, both are feasible options.

The collet connection portion preferably has a cylindrical shape.

The collet front bore may extend into the collet connection portion to allow tools having longer shanks to extend therein. To ensure proper clamping of a tool, the collet front bore extending into the collet connection portion may have a collet connection diameter D4 fulfilling the condition: D4>D1.

The collet can preferably comprise an external annular recess formed at the collet outer peripheral surface between the collet tapered portion and the collet connection portion. The external annular recess has an external annular recess axial length L7. Such feature is known as a result of producing the collet tapered portion. To facilitate a long tapering portion axial length LT, the external annular recess axial length L7 was minimized. Preferably L7<4 mm, more preferably L7<3 mm. Alternatively, preferably L7<0.1LC, more preferably L7<0.07LC.

Regarding the collet inward direction and collet outward direction mentioned above, and other inward and outward directions mentioned below, it will be understood that this does not refer to one specific direction but all outward and inward directions along the associated axis.

Generally speaking, when an “axial” length is mentioned it is meant a length measured parallel to the axis of the respective component being defined.

The tapering portion axial length LT is defined from the collet front end disregarding chamfers or radii, which are sufficiently small to be considered insignificant.

It will also be understood that the flexibility slits mentioned above can advantageously open out to the collet front end for production purposes. However, as their function merely requires that the collet be able to flex at the tapered area thereof, it is possible that some or all of the flexible slits could open out to a rear end of the collet, or possibly not open out to a specific end at all, as long as flexibility is achieved.

As the present invention is desired to be compact, it is advantageous that the flexibility slits be thin, with a slit width WS of less than 0.6 mm (WS<0.6 mm), and preferably significantly less than that (WS<0.4 mm). It will be understood that thicker slits could weaken the collet tapered portion excessively affecting precision of clamping. A preferred range for slit width is: 0.1 mm≤WS≤0.6 mm. Bearing in mind current cost considerations, the most preferred slit range: 0.2 mm≤WS≤0.3 mm, although it may be with cost reductions an even smaller width may be preferred in future.

It is advantageous that there be an even number of flexibility slits, with pairs of flexibility slits being located opposite to each other to allow them to be produced by a wire-cutting manufacturing method. While such method is typically far more expensive than traditional slitting methods, it is preferred for the purpose of compactness. Similarly, for wire-cutting it is preferred that all of the flexibility slits open out to the front end of the collet.

Reverting to the advantageous double clamping design, it is believed the most important clamping area is the region adjacent to the collet front end.

Specifically, it is believed the forwardmost clamping area is beneficially as close to the front end as possible, noting that a certain axial length is still needed to provide an appropriate clamping force. Accordingly, advantageously, the collet further comprises a sixth axial length L6 measurable from the collet front end to the first rearwardmost point and fulfilling the condition: L6<0.4LT. It should be understood that this feature defines the forwardmost clamping of the tool inserted in the collet to be relatively close to the collet front end. Accordingly, more preferably L6<0.2LT. While a specific minimal axial length axial length is untested, in theory it is believed that L6 should preferably be greater than 0.1LT (L6>0.08LT) to provide a sufficient clamping force, more preferably L6>0.11LT. As a side point, a front end chamfer shown in the present drawings could theoretically also be smaller, which would allow the sixth axial length L6 to be smaller than exemplified in the drawings.

The collet can advantageously comprise a fourth axial length L4 measurable from the collet front end to the second forwardmost point, and fulfilling the condition: L4>0.5LT, preferably L4>0.6LT. While a specific second axial length L2 length is untested, in theory it is believed that L2 should preferably be greater than 0.08LT. Accordingly it is preferred that L4<0.9LT. As explained above, the most stable clamping configuration with two clamping portions is with the tool's shank to be gripped as far away as possible. Accordingly, this feature defines that the second cylindrical clamping surface is significantly spaced apart from the first cylindrical clamping surface which is near the collet front end.

During development, it was found that while the first and second cylindrical clamping surfaces can be made of equal axial length, which would have ensured that they are both have as small an axial length as possible and also located at distal ends of the collet tapered portion, an advantage is believed to exist (over ensuring distal clamping positions) by having a greater axial length of the second cylindrical clamping surface (L2>L1). This is done to bring the clamping forces of both clamping surfaces into closer magnitudes, since a greater force is applied by a holder body on a drawback collet near the front end thereof. In order to ensure a similar clamping force at both clamping surfaces, which in theory is believed advantageous, such an increase in length was incorporated into the present design, with a preference for L2>2L1. This consideration similarly explains why the exemplified embodiment has a second forwardmost point closer than the first rearwardmost point to the middle of the collet tapered portion. Preferably L2>3L1 in the design developed which brings estimated clamping forces even closer to equality. For similar considerations it is preferred that L2<5L1 and L2<4L1.

Nonetheless, the rearmost portion of the second cylindrical clamping surface should be as distally located as possible from the collet front end of the collet. Accordingly, the collet can further comprise a fifth axial length L5 measurable from the collet front end to the second rearwardmost point, and preferably L5>0.8LT, more preferably L5>0.9LT and even most preferably L5>LT to ensure clamping at the most distal point of the compressible tapered portion. Nonetheless, to not overly lengthen the collet, it is preferred that L5<1.2LT.

While the features above may be advantageous even for a non-drawback collet of the type exemplified, it will be understood that such features were found advantageous for a drawback tool holder's collet. Accordingly, it is advantageous that the collet's tapered portion reduces in diameter with increasing distance from the collet front end.

In order to achieve the goal of a similar compact construction (small diameter) and high clamping forces as found in a heat-shrink tool holder, a delicate balance of angles and length of the collet had to be achieved. It was found advantageous for a collet core angle C of the tapering portion fulfill the condition: 4°<C<8°, preferably 5°<C<7°. It will be understood that too small a core angle may not function well, and a larger core angle than those above resultantly require an increase the tool holder diameter.

Typically, an axial clamping length of up to three times the bore diameter is considered sufficient to clamp a shank of a tool. According to the present aspect, where a continuous clamping region is sacrificed to achieve two distal spaced-apart clamping portions, the rearmost clamping portion potentially assists in achieving greater clamping forces and better precision clamping, it was also conceived to have a longer tapering portion axial length LT to increase said advantages. Accordingly, it is preferred that LT>3.1D1, and more preferably LT>3.3D1. To explain, only the collet tapered portion which is compressed by a holder body is assumed to be the area where the tool is clamped. In consideration of the remainder of features of the holder, such as the structural strength (thickness) of the collet and holder body at the front ends thereof, which will need to be thinner if the collet tapering portion is overly long, an upper limit of LT<4D1 is preferred. The preferred embodiment fulfilling the condition LT=3.5D1±0.1D1. Notably, this feature, and others above, is defined in terms of D1, although it could alternatively be defined in terms of D2.

In accordance with another aspect of the present invention there is provided a nut having a nut axis which extends through a center of the nut, the nut comprising: a nut front end; a nut rear end located opposite the nut front end; a nut body extending between the nut front end and the nut rear end; a nut rearward direction from the nut front end to the nut rear end and parallel to the nut axis; a nut forward direction opposite to the nut rearward direction; a nut outward direction perpendicular to the nut axis and from the nut axis towards the nut body; a nut inward direction opposite to the nut outward direction; and a nut through bore opening out to the nut front end at a nut front opening, the nut through bore extending rearward from the nut front end; the nut body comprising: a nut outer peripheral surface; a nut inner peripheral surface in turn formed with nut threading, and an internal annular recess; the nut inner peripheral surface comprising: a lower lip having a lower axial length LL and a lower lip diameter D5; an upper lip closer than the lower lip to the nut front end and having an upper axial length LU and an upper lip diameter D6; and a side surface connecting the lower lip and upper lip, and having a minimum axial length LMI and a recess diameter D7; the nut further comprising an internal ring located in the internal annular recess; the internal ring comprising: a ring outer peripheral surface having a maximum axial length LMA and a ring diameter D8; a ring inner peripheral surface; a ring upper surface connecting the ring outer peripheral surface and the ring inner peripheral surface; and a ring lower surface located opposite the ring upper surface and connecting the ring outer peripheral surface and the ring inner peripheral surface; the ring diameter D8 fulfilling the conditions: D8>D5, D8>D6 and D8<D7, thereby allowing the internal ring to rotate independently about the nut axis independent relative to the nut body but being limited in axial movement by the lower lip and upper lip; the nut body further comprising a nut first aperture opening to the nut outer peripheral surface and the side surface; the internal ring further comprising: a ring first aperture opening out to the ring outer peripheral surface and the ring inner peripheral surface; a ring second aperture opening out to the ring outer peripheral surface and the ring inner peripheral surface, and being located opposite to the ring first aperture; the nut first aperture being positioned on the nut body and the ring first aperture being positioned on the internal ring such that the nut first aperture and ring first aperture can be aligned with each other.

In order to reduce the number of components of a holder an additive manufacturing nut was developed with a captive, independently rotating internal ring configured for holding a pin of the holder. One machining advantage (reduced overhang length of the holder body) is connected to generally to a captive internal ring formed together with the nut body, it will be described below. The present aspect is independently directed to an advantageous design which prevents a pin held by the internal ring. Namely, since the nut is brought to a secured position on a holder via a threading the chance that the final secured position will bring the nut first aperture and ring first aperture into perfect alignment such that during machining or even pre-machining handling could be accidentally ejected is remarkably small.

To even further reduce the chance of accidental ejection, the minimum axial length LMI may fulfill the condition: LMI>LMA+0.1 mm, thereby allowing the internal ring to axially translate within the internal annular recess such that the nut first aperture and the ring first aperture can be positioned out of axial alignment. In other words, such feature means that not only can the nut first aperture and ring first aperture be rotationally unaligned, but also axially unaligned, further reducing the possibility of accidental ejection. Even more preferably, the nut first aperture is positioned on the nut body and the ring first aperture is positioned on the internal ring such that the nut first aperture and ring first aperture can be aligned with each other only when the internal ring is axially spaced-apart from both the lower lip and the upper lip.

To assist ejection, preferably the nut body further comprises a nut second aperture located opposite and being smaller than the nut first aperture. As the nut second aperture is smaller the pin cannot exit it, but a pin can be inserted into it to eject the pin from the nut first aperture, after proper alignment with the ring first aperture.

Preferably the nut threading is formed on the lower lip and the lower lip fulfills the condition: LL>LU. Stated differently, the internal ring is axially closer to the nut front end. This feature allows a reduced overhang length for a holder, as will be discussed below.

During testing it was found that the high levels of force provided by the nut there is a risk of the pin snapping. To reduce the risk of over-tightening, unique wrench and corresponding wrench recesses were developed to ensure that standard wrenches could not accidentally be used on the tool. Accordingly, preferably, the wrench recesses open out to the nut front end and there are more than six recesses. It will be understood that the nut can alternatively be devoid of wrench recesses as there are known tools which can grip smooth cylindrical nuts and tighten or loosen them.

In accordance with another aspect of the present invention there is provided a holder body having an elongated shape and a holder axis which extends longitudinally through a center of the holder body, the holder body comprising: a holder front end; a holder rear end located opposite the holder front end; a holder rearward direction from the holder front end to the holder rear end and parallel to the holder axis; a holder forward direction opposite to the holder rearward direction; a holder outward direction perpendicular to the holder axis and from the holder axis towards the holder body; a holder inward direction opposite to the holder outward direction; a holder front bore opening out to the holder front end at a holder front opening, the holder front bore extending rearward from the holder front end; a holder diameter DH at the holder front end; a holder outer peripheral surface; and a holder inner peripheral surface; the holder body further comprising: a holder connection portion extending forward from the holder rear end; a holder clamping portion extending rearward from the holder front end and having a clamping portion axial length LH; and a holder drawback portion located between the holder connection portion and the holder clamping portion; the holder clamping portion comprising a holder inner tapered portion axially adjacent to the holder front bore and formed at the holder inner peripheral surface; the holder inner tapered portion increasing in diameter with increased proximity to the holder front end and comprising a holder core angle H; the holder drawback portion comprising: a drawback aperture opening out at one side to the holder outer peripheral surface and at the other side to the holder inner peripheral surface, and being elongated in the holder forward direction and holder rearward direction; and a holder threading located between the drawback aperture and the connection portion.

The holder body defined is for a drawback tool holder, due to the tapering direction of the holder inner tapered portion, with a nut and pin system (described separately). The pin is able to be inserted in the drawback aperture in an axial motion when the nut is rotated in contact with the holder threading. This is similar to the disclosure of JP2016-124070A, except that in said publication a chucking system which pushes a three-piece chuck axially forward into the holder body to clamp a tool, whereas in this aspect a drawback holder body is defined. By contrast, in Yukiwa Seiko's holder, which also has a drawback holder body positions the holder threading between the drawback aperture and the holder front end and not as defined above, namely between the drawback aperture and the connection portion.

In both FIG. 3 of JP2016-124070A (the lip indicated by “11”) and Yukiwa Seiko's holder an integral lip portion of the nut is used to thrust the pin in the desired clamping direction. On the opposite side of the integral lip is a ring element (for example indicated by “7” in FIG. 3 of JP2016-124070A) which is used to mount the nut around the pin (in Yukiwa Seiko's holder it is a threaded ring). Accordingly, in Yukiwa Seiko's holder in order to assemble the components, the threading on the holder body was positioned closer to the holder front end.

In the holder described herein, where the above-described nut with a captive internal ring is utilized and the pin is inserted through the nut into the holder body, with a risk of accidental ejection which has been mitigated as described above, the holder threading may be advantageously positioned between the drawback aperture and the connection portion, increasing the overhang length of the holder body and consequently the holder itself. By “overhang length” it is meant the length of the holder clamping portion forward of the nut and until the holder front end (i.e. the length which has a diameter smaller than that of the nut, allowing closer machining to workpiece walls etc.), this is identified as “LO” as shown in FIG. 2A. This advantage also relates to the nut features mentioned above which refer to the advantageous reduced overhang length (e.g. by the tool's shank being clamped as close as possible to the cutting portion of a tool).

The holder connection portion shown is a standard ER connection, and it will be understood that any standard connection type for a tool holder is possible.

The drawback aperture can preferably be oval shaped.

The pin is preferably cylindrical, but could have, for example, a square cross section instead of a circular cross section.

In a preferred embodiment the holder outer peripheral surface comprises a holder outer tapered portion axially adjacent to the holder front bore and decreasing in diameter with increased proximity to the holder front end. This is similar to heat-shrink tool holders which allows closer machining in space limited areas. However, it will be understood that a non-tapered holder outer peripheral surface is certainly an option.

According to yet another aspect there is provided a holder comprising: a holder body; a collet located in the holder body; a nut mounted to the holder body; a cylindrical pin configured to draw the collet into the holder body upon rotation of the nut; wherein at least one of the following conditions is fulfilled: the collet is in accordance with the collet aspect above; the nut is in accordance with the nut aspect above; and the holder body is in accordance with the holder body aspect above.

It will be understood that each of the collet, nut, and holder body may be independently advantageous, and any combination of these components may be used together.

The collet core angle C is preferably larger than the holder core angle H to ensure that the collet tapered portion is compressed properly. However, it will be understood that the difference is as small as possible, preferably less than 0.02°.

It will be understood that the present invention in order to be compact, the holder and components were designed to have as few pieces as possible. The holder either comprises in total five components: namely a holder body, a nut, a pin, a collet, and a collet drawback element detachably attached to the collet; or the holder comprises a total of four components: namely a holder body, a nut, a pin, and a collet with the collet comprising an integrally formed collet drawback element.

### BRIEF DESCRIPTION OF THE DRAWINGS

For a better understanding of the subject matter of the present application, and to show how the same may be carried out in practice, reference will now be made to the accompanying drawings, in which:

FIG. 1A is a perspective view of a holder;

FIG. 1B is another perspective view of the holder in FIG. 1A;

FIG. 2A is a side view of the holder in FIG. 1A holding a schematically shown tool;

FIG. 2B is a sectional view taken along line IIA-IIA in FIG. 2A;

FIG. 3A is a top view of a holder body of the holder in FIG. 1A;

FIG. 3B is a side view of the holder body in FIG. 3A;

FIG. 3C is side view of the holder body in FIG. 3B rotated 90°;

FIG. 3D is a bottom view of the holder body in FIG. 3B;

FIG. 4A is a top view of a collet drawback element of the holder in FIG. 1A;

FIG. 4B is a side view of the collet drawback element in FIG. 4A;

FIG. 4C is a sectional view taken along line IVC-IVC in FIG. 4B;

FIG. 4D is a side view of the collet drawback element in FIG. 4B rotated 90°;

FIG. 4E is a sectional view taken along line IVE-IVE in FIG. 4D;

FIG. 4F is a bottom view of the collet drawback element in FIG. 4B;

FIG. 5A is a top view of a collet of the holder in FIG. 1A;

FIG. 5B is a side view of the collet in FIG. 5A;

FIG. 5C is a sectional view taken along line VC-VC in FIG. 5B;

FIG. 5D is a bottom view of the collet in FIG. 5B;

FIG. 5E is a top view of a collet in FIG. 5A rotated 45°;

FIG. 5F is a side view of the collet in FIG. 5B rotated 45°;

FIG. 5G is a sectional view taken along line VG-VG in FIG. 5F;

FIG. 5H is a bottom view of the collet in FIG. 5F;

FIG. 6A is a top view of a nut of the holder in FIG. 1A;

FIG. 6B is a side view of the nut in FIG. 6A;

FIG. 6C is a side view of the nut in FIG. 6B rotated 90°;

FIG. 6D is a side view of the nut in FIG. 6B rotated 180°;

FIG. 6E is a bottom view of the nut in FIG. 6C;

FIG. 6F is a sectional view taken along line VIF-VIF in FIG. 6B;

FIG. 6G is a sectional view taken along line VIG-VIG in FIG. 6C;

FIG. 7A is a top view of a pin of the holder in FIG. 1A;

FIG. 7B is a side view of the pin in FIG. 7A;

FIG. 8A is a side view of the holder in FIG. 1A;

FIG. 8B is a top view of the holder in FIG. 8A;

FIG. 8C is a side view of the holder in FIG. 8B; and

FIG. 8D is a bottom view of the holder in FIG. 8C.

### DETAILED DESCRIPTION

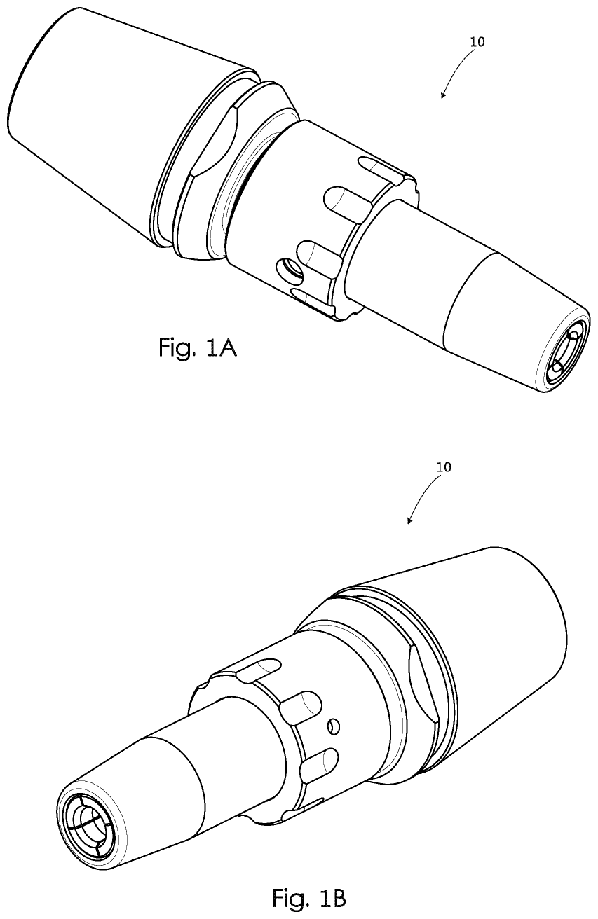

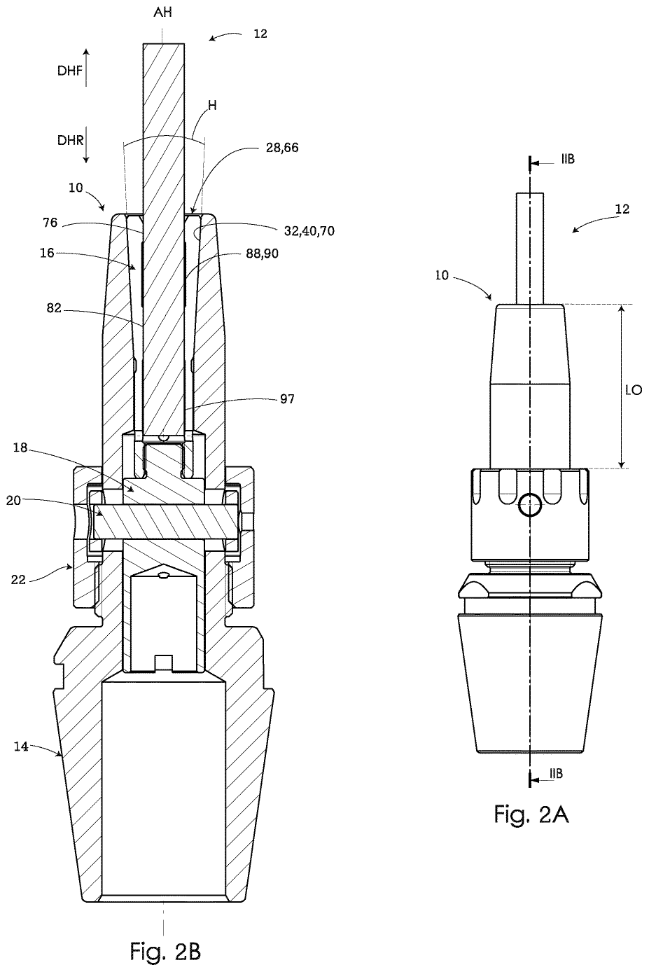

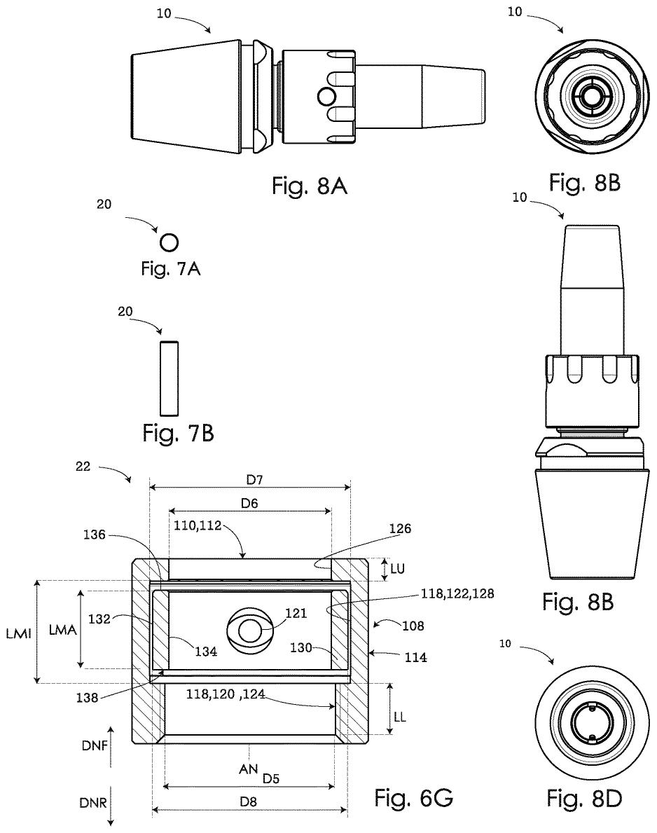

Reference is made to FIGS. 1A, 1B, and 8A to 8D which illustrate an exemplary holder 10 of a drawback type. Referring also to FIGS. 2A and 2B, the holder 10 is shown clamping a shank of a schematically shown tool 12.

The holder 10 comprises a holder body 14, a collet 16, a collet drawback element 18, a pin 20 and a nut 22.

The holder body 14 has a holder axis AH defining a holder forward direction DHF and a holder rearward direction DHR.

To briefly describe clamping the tool 12 to the holder 10: the tool 12 is inserted in the collet 16 and the nut 22 is rotated. Upon rotation, the nut 22 pulls the pin 20 in the holder rearward direction DHR (the pin 20 itself not rotating) which in turn pulls the collet drawback element 18 and the collet 16 together with it. The collet 16 clamps the tool 12 when being compressed by the holder body 14.

Since the nut 22 can be accessed even when the holder 10 is already mounted to another holder or a machine interface, said mounting can be before or after clamping of the tool 12. It will be understood that the nut 22 allowing clamping and releasing of the tool 12 while the holder 10 is mounted is advantageous. The tool 12 is then used to machine a workpiece (not shown).

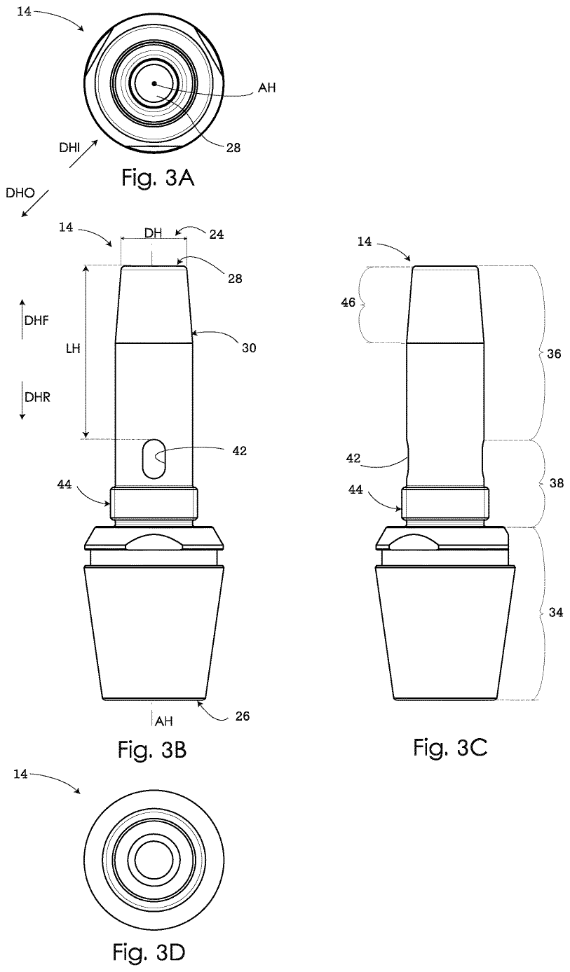

Referring to FIGS. 2B and 3A to 3D, the holder body 14 will be described in detail.

The holder body 14 comprises: a holder front end 24; a holder rear end 26; a holder rearward direction DHR; a holder forward direction DHF; a holder outward direction DHO being directed radially outward from the holder axis AH; a holder inward direction DHI being directed radially inward from the holder axis AH; a holder front bore 28; a holder diameter DH at the holder front end 24; a holder outer peripheral surface 30; and a holder inner peripheral surface 32.

The holder body 14 comprises a holder connection portion 34; a holder clamping portion 36; and a holder drawback portion 38 located axially between the holder connection portion 34 and the holder clamping portion 36.

The holder clamping portion 36 comprises a holder inner tapered portion 40 comprising a holder core angle H.

The holder drawback portion 38 comprises a drawback aperture 42 and a holder threading 44.

The holder clamping portion 36 and its holder clamping portion axial length LH is defined from the top of the drawback aperture 42 to the holder front end 24.

The holder outer peripheral surface 30 comprises a holder outer tapered portion 46.

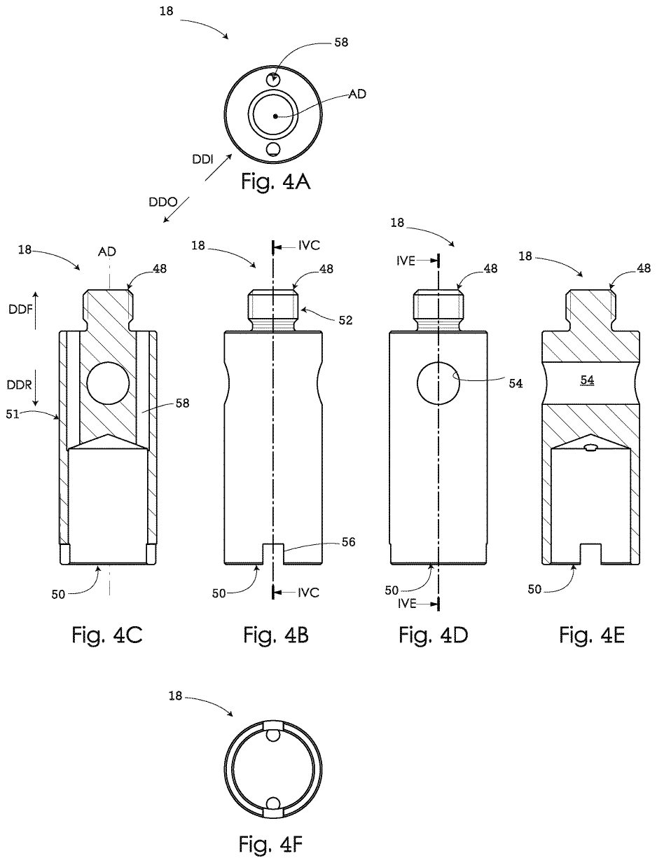

Referring to FIGS. 4A to 4F, the collet drawback element 18 will be described in detail.

The collet drawback element 18 has a drawback axis AD defining a drawback forward direction DDF and a drawback rearward direction DDR.

The collet drawback element 18 comprises: a drawback front end 48; a drawback rear end 50; a cylindrical drawback peripheral surface 51 extending between the drawback front end 48 to the drawback rear end 50; a drawback outward direction DDO being directed radially outward from the drawback axis AD; a drawback inward direction DDI being directed radially inward from the drawback axis AD; a drawback threaded projection 52 at the drawback front end 48; a drawback aperture 54 extending through the drawback peripheral surface 51; a drawback keyway 56 and at least one drawback coolant passageway 58.

It will be understood that the drawback threaded projection 52 is just a preferred means for connecting the collet drawback element 18 to the collet 16. Any other method of connecting the collet 16 and the collet drawback element 18 is acceptable, for example an integral alternative is possible as mentioned above.

The coolant passageway 58 could be internal as shown or an external groove or grooves, or combination of internal and external pathways.

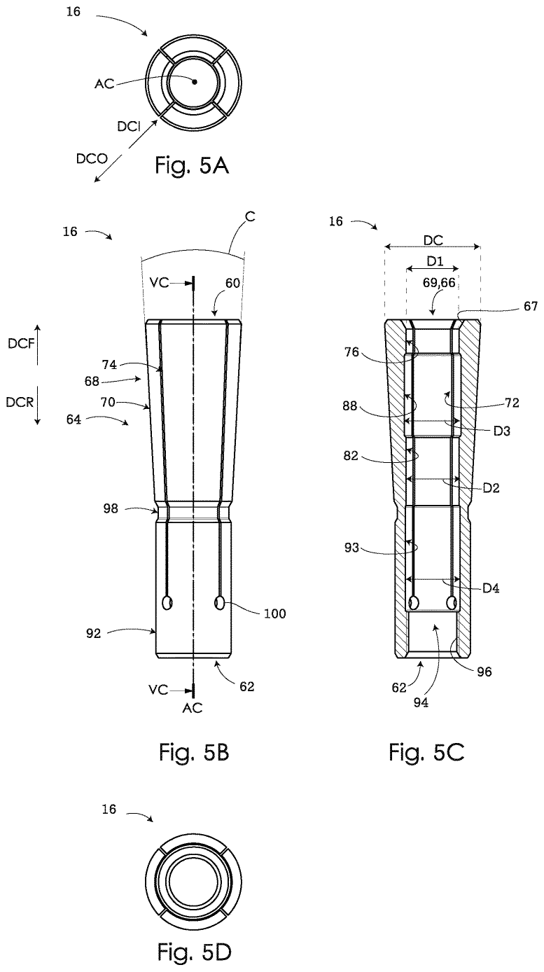

Referring to FIGS. 2B and 5A to 5H, the collet 16 will be described in detail.

The collet 16 has a collet axis AC and comprises: a collet front end 60; a collet rear end 62 a collet body 64; a collet rearward direction DCR; a collet forward direction DCF; a collet outward direction DCO being directed radially outward from the collet axis AC; a collet inward direction DCI being directed radially inward from the collet axis AC; a collet diameter DC at the collet front end; a collet axial length LC; and a collet front bore 66 having a collet chamfer 67 at the front end 60 and opening out to the collet front end at a collet front opening 69.

The collet body 64 comprising: a collet outer peripheral surface 68 in turn comprising a collet tapered portion 70 having a tapering portion axial length LT; a collet inner peripheral surface 72; and a plurality of flexibility slits 74. The flexible slits 74, in the collet inward direction DCI and the collet outward direction DCO extending from the collet outer peripheral surface 68 to the collet inner peripheral surface 72. Moreover, the flexible slits 74 preferably extending from the collet front end 60 in the collet rearward direction DCR.

The collet inner peripheral surface 72 comprises: a first cylindrical clamping surface 76 in turn comprising a first forwardmost point 78, a first rearwardmost point 80, a first bore diameter D1, and a first axial length L1 extending from the first forwardmost point 78 to the first rearwardmost point 80; a second cylindrical clamping surface 82 in turn comprising a second forwardmost point 84, a second rearwardmost point 86, a second bore diameter D2 equal to the first bore diameter D1, and a second axial length L2 extending from the second forwardmost point 84 to the second rearwardmost point 86; and a recess 88 having a third axial length L3 from the first rearwardmost point 80 to the second forwardmost point 84, and a recess bore diameter D3.

Drawing attention particularly to FIG. 2B, it is shown that the tool 12 is only clamped at two locations. Clamping may specifically occur at the first cylindrical clamping surface 76 and the second cylindrical clamping surface 82, with a first gap 90 along the recess 88.

The collet 16 further comprises a collet connection portion 92. At the collet connection portion 92 the collet front bore 66 has a collet connection diameter D4. The collet connection portion 92 is formed with a collet back bore 94 formed with a collet thread 96. As the collet connection diameter D4 is larger than the first bore diameter D1, there is a second gap 97 at that location since the tool 12 is not intended to be clamped there.

The collet can preferably comprise an external annular recess 98 having an external annular recess axial length L7.

The flexibility slits 74 can have enlarged portions 100 to ease manufacturing.

In the preferred embodiment there are four flexibility slits 74 (74A,74B,74C,74C), dividing the collet tapered portion 70 into four tapered flexing arms (102A, 102B, 102C, 102D). Since these very thin metal flexing arms can be easily damaged and are required to provide a precision function, it is advantageous that the flexibility slits have a thin slit width WS.

As shown in FIG. 5D, the collet 16 further has a fourth axial length L4, fifth axial length L5, and sixth axial length L6.

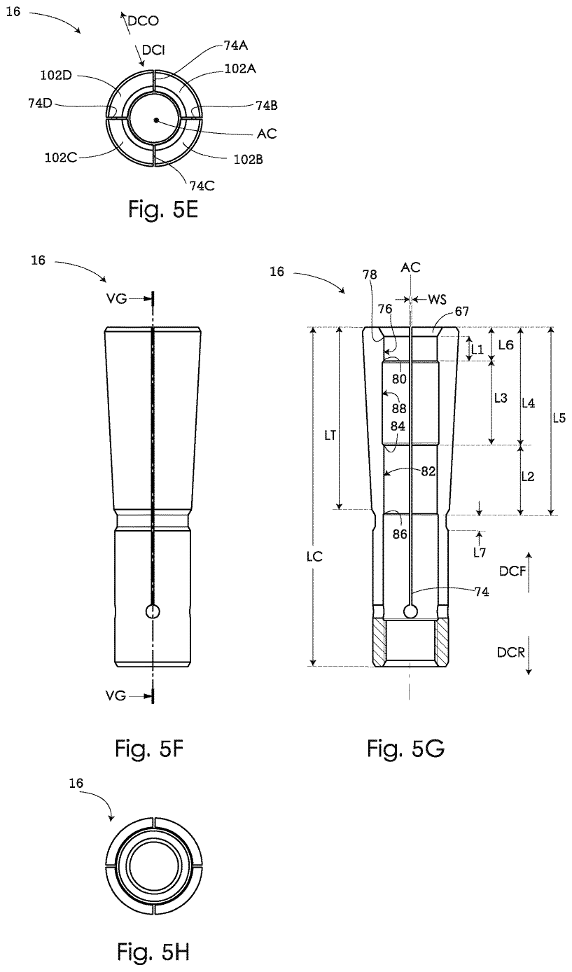

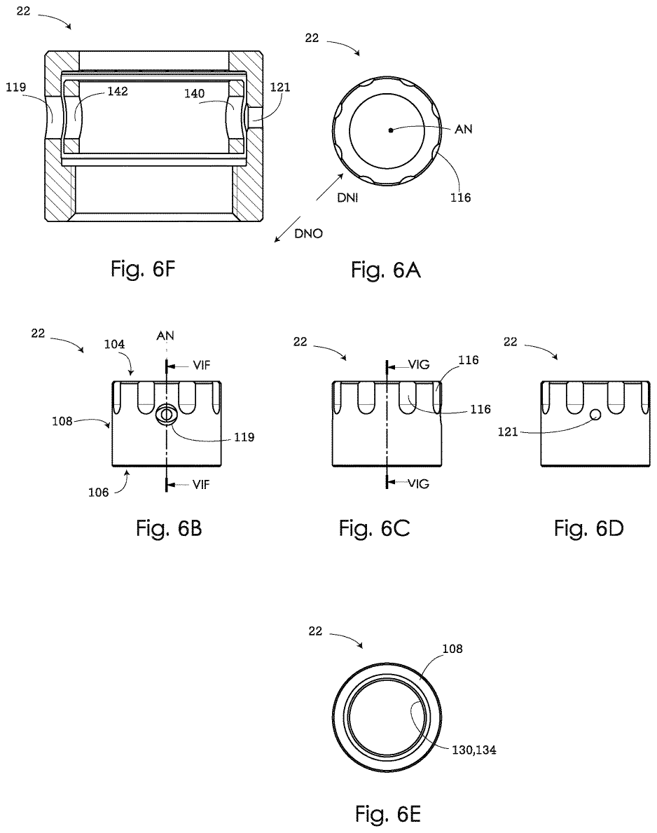

Referring to FIGS. 2B and 6A to 6F, the nut 22 will be described in detail.

The nut 22 having a nut axis AN and comprising: a nut front end 104; a nut rear end 106; a nut body 108; a nut rearward direction DNR; a nut forward direction DNF; a nut outward direction DNO; a nut inward direction DNI; and a nut through bore 110 opening out to the nut front end at a nut front opening 112.

The nut body 108 comprising: a nut outer peripheral surface 114 in turn comprising wrench recesses 116; a nut inner peripheral surface 118 in turn formed with a nut threading 120; a nut first aperture 119; a nut second aperture 121 (which may be smaller than the nut first aperture 119 to prevent ejection of the pin); and an internal annular recess 122.

The internal annular recess 122 comprises: a lower lip 124 having a lower axial length LL and a lower lip diameter D5; an upper lip 126 having an upper axial length LU and an upper lip diameter D6; and a side surface 128 having a minimum axial length LMI and a recess diameter D7.

The nut 22 further comprises an internal ring 130 located in the internal annular recess 122. The internal ring 130 is a separate component from the nut body 108 and can move independently thereof within certain limits.

The internal ring 130 comprising: a ring outer peripheral surface 132 having a maximum axial length LMA and a ring diameter D8; a ring inner peripheral surface 134; a ring upper surface 136; and a ring lower surface 138; a ring first aperture 140; and a ring second aperture 142.

What is claimed is:

1. A collet having an elongated shape and a collet axis which extends longitudinally through a center of the collet, the collet comprising:
a collet front end;
a collet rear end located opposite the collet front end;
a collet body extending between the collet front end and the collet rear end;
a collet rearward direction from the collet front end to the collet rear end and parallel to the collet axis;
a collet forward direction opposite to the collet rearward direction;
a collet outward direction perpendicular to the collet axis and from the collet axis towards the collet body;
a collet inward direction opposite to the collet outward direction;
a collet diameter DC at the collet front end;
a collet axial length LC; and
a collet front bore opening out to the collet front end at a collet front opening, the collet front bore extending rearward from the collet front end;
the collet body comprising:
a collet outer peripheral surface in turn comprising a collet tapered portion axially adjacent to the collet front bore;
a collet inner peripheral surface surrounding at least the collet front bore; and
a plurality of flexibility slits formed in the collet body and opening out at one side to the collet front bore and at the other side to the collet tapered portion;
a tapering portion axial length LT is defined from the collet front end to a distal end of the collet tapered portion;
wherein the collet has a double clamping design;
wherein the collet inner peripheral surface comprises:
a first cylindrical clamping surface in turn comprising a first forwardmost point, a first rearwardmost point, a first bore diameter D1, and a first axial length L1 measurable from the first forwardmost point to the first rearwardmost point;
a second cylindrical clamping surface in turn comprising a second forwardmost point, a second rearwardmost point, a second bore diameter D2 equal to the first bore diameter D1, and a second axial length L2 measurable from the second forwardmost point to the second rearwardmost point; and
a recess located between the first cylindrical clamping surface and the second cylindrical clamping surface and having a third axial length L3 from the first rearwardmost point to the second forwardmost point, and a recess bore diameter D3 fulfilling the conditions: D3>D1 and D3>D2;
and wherein: the collet further comprises a sixth axial length L6 measurable from the collet front end to the first rearwardmost point and fulfilling the condition: L6<0.4LT.

2. The collet as claimed in claim 1, fulfilling the condition: L6<0.2LT.

3. The collet as claimed in claim 1, further comprising a fourth axial length L4 measurable from the collet front end to the second forwardmost point, and fulfilling the condition: L4>0.5LT.

4. The collet as claimed in claim 1, further comprising a fifth axial length L5 measurable from the collet front end to the second rearwardmost point, and fulfilling the condition: L5>0.8LT.

5. The collet as claimed in claim 4, fulfilling the condition: L5>LT.

6. The collet as claimed in claim 1, fulfilling the condition: L2>L1.

7. The collet as claimed in claim 6, fulfilling the condition: L2>2L1.

8. The collet as claimed in claim 1, wherein a collet core angle C of the collet tapered portion fulfills the condition: 4°<C<8°.

9. The collet as claimed in claim 1, fulfilling the condition: LT>3.1D1.

10. The collet as claimed in claim 9, fulfilling the condition: LT>3.3D1.

11. The collet as claimed in claim 1, wherein the flexibility slits have a slit width WS fulfilling the condition: 0.2 mm≤WS≤0.6 mm.

12. The collet as claimed in claim 1, wherein at least some of the flexibility slits open out to the collet front end.

13. A nut having a nut axis which extends through a center of the nut, the nut comprising:
a nut front end;
a nut rear end located opposite the nut front end;
a nut body extending between the nut front end and the nut rear end;
a nut rearward direction from the nut front end to the nut rear end and parallel to the nut axis;
a nut forward direction opposite to the nut rearward direction;
a nut outward direction perpendicular to the nut axis and from the nut axis towards the nut body;
a nut inward direction opposite to the nut outward direction; and
a nut through bore opening out to the nut front end at a nut front opening, the nut through bore extending rearward from the nut front end;
the nut body comprising:
a nut outer peripheral surface; and
a nut inner peripheral surface in turn formed with nut threading, and an internal annular recess;
the nut inner peripheral surface comprising:
a lower lip having a lower axial length LL and a lower lip diameter D5;
an upper lip closer than the lower lip to the nut front end and having an upper axial length LU and an upper lip diameter D6; and
a side surface connecting the lower lip and upper lip, and having a minimum axial length LMI and a recess diameter D7;
the nut further comprising an internal ring located in the internal annular recess;
the internal ring comprising:
a ring outer peripheral surface having a maximum axial length LMA and a ring diameter D8;
a ring inner peripheral surface;
a ring upper surface connecting the ring outer peripheral surface and the ring inner peripheral surface; and
a ring lower surface located opposite the ring upper surface and connecting the ring outer peripheral surface and the ring inner peripheral surface;
the ring diameter D8 fulfilling the conditions: D8>D5, D8>D6 and D8<D7, thereby allowing the internal ring to rotate independently about the nut axis relative to the nut body but being limited in axial movement by the lower lip and the upper lip;
the nut body further comprising a nut first aperture opening to the nut outer peripheral surface and the side surface;
the internal ring further comprising:
a ring first aperture opening out to the ring outer peripheral surface and the ring inner peripheral surface; and
a ring second aperture opening out to the ring outer peripheral surface and the ring inner peripheral surface, and being located opposite to the ring first aperture;
the nut first aperture is positioned on the nut body and the ring first aperture is positioned on the internal ring such that the nut first aperture and the ring first aperture can be aligned with each other.

14. The nut as claimed in claim 13, wherein the minimum axial length LMI fulfills the condition: LMI>LMA+0.1 mm, thereby allowing the internal ring to axially translate within the internal annular recess such that the nut first aperture and the ring first aperture can be brought to a position out of axial alignment.

15. The nut as claimed in claim 14, wherein the nut first aperture is positioned on the nut body and the ring first aperture is positioned on the internal ring such that the nut first aperture and the ring first aperture can only be aligned with each other when the internal ring is axially spaced-apart from both the lower lip and the upper lip.

16. The nut as claimed in claim 13, wherein the nut threading is formed on the lower lip and the lower lip fulfills the condition: LL>LU.

17. The nut as claimed in claim 13, wherein the nut body further comprises a nut second aperture located opposite the nut first aperture and being smaller than the nut first aperture.

18. The nut as claimed in claim 13, wherein the nut outer peripheral surface comprises wrench recesses which open out to the nut front end and there are more than six wrench recesses.

19. A holder body having an elongated shape and a holder axis which extends longitudinally through a center of the holder body, the holder body comprising:
a holder front end;
a holder rear end located opposite the holder front end;
a holder rearward direction from the holder front end to the holder rear end and parallel to the holder axis;
a holder forward direction opposite to the holder rearward direction;
a holder outward direction perpendicular to the holder axis and from the holder axis towards the holder body;
a holder inward direction opposite to the holder outward direction;
a holder front bore opening out to the holder front end at a holder front opening, the holder front bore extending rearward from the holder front end;
a holder diameter DH at the holder front end;
a holder outer peripheral surface;
a holder inner peripheral surface;
a holder connection portion extending forward from the holder rear end;
a holder clamping portion extending rearward from the holder front end and having a clamping portion axial length LH; and
a holder drawback portion located between the holder connection portion and the holder clamping portion;
the holder clamping portion comprising a holder inner tapered portion axially adjacent to the holder front bore and formed at the holder inner peripheral surface;
the holder inner tapered portion increasing in diameter with increased proximity to the holder front end and comprising a holder core angle H;
the holder drawback portion comprising:
a drawback aperture opening out at one side to the holder outer peripheral surface and at the other side to the holder inner peripheral surface, and the drawback aperture is elongated in the holder forward direction and the holder rearward direction; and
a holder threading located between the drawback aperture and the holder connection portion.

20. A holder comprising:
a holder body;
a collet located in the holder body;
a nut mounted to the holder body; and
a cylindrical pin configured to draw the collet into the holder body upon rotation of the nut,
wherein at least one of the following conditions is fulfilled:
(a) the collet is in accordance with claim 1;
(b) the nut having a nut axis which extends through a center of the nut, the nut comprising:
a nut front end;
a nut rear end located opposite the nut front end;
a nut body extending between the nut front end and the nut rear end;
a nut rearward direction from the nut front end to the nut rear end and parallel to the nut axis;
a nut forward direction opposite to the nut rearward direction;
a nut outward direction perpendicular to the nut axis and from the nut axis towards the nut body;
a nut inward direction opposite to the nut outward direction; and
a nut through bore opening out to the nut front end at a nut front opening, the nut through bore extending rearward from the nut front end;
the nut body comprising:
a nut outer peripheral surface; and
a nut inner peripheral surface in turn formed with nut threading, and an internal annular recess;
the nut inner peripheral surface comprising:
a lower lip having a lower axial length LL and a lower lip diameter D5;
an upper lip closer than the lower lip to the nut front end and having an upper axial length LU and an upper lip diameter D6; and
a side surface connecting the lower lip and upper lip, and having a minimum axial length LMI and a recess diameter D7;
the nut further comprising an internal ring located in the internal annular recess;
the internal ring comprising:
a ring outer peripheral surface having a maximum axial length LMA and a ring diameter D8;
a ring inner peripheral surface;
a ring upper surface connecting the ring outer peripheral surface and the ring inner peripheral surface; and
a ring lower surface located opposite the ring upper surface and connecting the ring outer peripheral surface and the ring inner peripheral surface;
the ring diameter D8 fulfilling the conditions: D8>D5, D8>D6 and D8<D7, thereby allowing the internal ring to rotate independently about the nut axis relative to the nut body but being limited in axial movement by the lower lip and the upper lip;
the nut body further comprising a nut first aperture opening to the nut outer peripheral surface and the side surface;
the internal ring further comprising:
a ring first aperture opening out to the ring outer peripheral surface and the ring inner peripheral surface; and
a ring second aperture opening out to the ring outer peripheral surface and the ring inner peripheral surface, and being located opposite to the ring first aperture;
the nut first aperture is positioned on the nut body and the ring first aperture is positioned on the internal ring such that the nut first aperture and the ring first aperture can be aligned with each other; and
(c) the holder body having an elongated shape and a holder axis which extends longitudinally through a center of the holder body, the holder body comprising:
a holder front end;
a holder rear end located opposite the holder front end;
a holder rearward direction from the holder front end to the holder rear end and parallel to the holder axis;
a holder forward direction opposite to the holder rearward direction;
a holder outward direction perpendicular to the holder axis and from the holder axis towards the holder body;
a holder inward direction opposite to the holder outward direction;
a holder front bore opening out to the holder front end at a holder front opening, the holder front bore extending rearward from the holder front end;
a holder diameter DH at the holder front end;
a holder outer peripheral surface;
a holder inner peripheral surface;
a holder connection portion extending forward from the holder rear end;
a holder clamping portion extending rearward from the holder front end and having a clamping portion axial length LH; and
a holder drawback portion located between the holder connection portion and the holder clamping portion;
the holder clamping portion comprising a holder inner tapered portion axially adjacent to the holder front bore and formed at the holder inner peripheral surface;
the holder inner tapered portion increasing in diameter with increased proximity to the holder front end and comprising a holder core angle H;
the holder drawback portion comprising:
a drawback aperture opening out at one side to the holder outer peripheral surface and at the other side to the holder inner peripheral surface, and the drawback aperture is elongated in the holder forward direction and the holder rearward direction; and
a holder threading located between the drawback aperture and the holder connection portion.

21. The holder as claimed in claim 20, wherein the holder either comprises in total five components: namely a holder body, a nut, a pin, a collet. and a collet drawback element detachably attached to the collet; or the holder comprises a total of four components: namely a holder body, a nut, a pin, and a collet, the collet comprising an integrally formed collet drawback element.
